(19) United States
(12) Patent Application Publication
(10) Pub. No.: US 2024/0223049 A1
(43) Pub. Date: Jul. 4, 2024

(54) DEVICE FOR CONTROLLING AN INVERTER/RECTIFIER

(71) Applicant: VALEO EQUIPEMENTS ELECTRIQUES MOTEUR, Creteil Cedex (FR)

(72) Inventor: Paul ARMIROLI, Creteil Cedex (FR)

(73) Assignee: VALEO EQUIPEMENTS ELECTRIQUES MOTEUR, Creteil Cedex (FR)

(21) Appl. No.: 18/555,175

(22) PCT Filed: Apr. 4, 2022
(86) PCT No.: PCT/EP2022/058854

§ 371 Date: Oct. 12, 2023

(30) Foreign Application Priority Data
Apr. 12, 2021 (FR) 21 03764
Apr. 12, 2021 (FR) 21 03766

(51) Int. Cl. H02K 11/33; B60K 1/00; B60K 6/26; B60K 6/36; B60K 17/04; H02K 1/27; H02K 7/00; H02K 7/116; H02K 11/25

(52) U.S. Cl. CPC H02K 11/33; H02K 1/27; H02K 7/003; H02K 7/116; H02K 11/25; B60K 1/00; B60K 6/26; B60K 6/36; B60K 17/04; B60Y 2200/91; B60Y 2200/92; B60Y 2400/60

(57) ABSTRACT

A device for controlling an inverter/rectifier capable of being electrically connected to the electrical stator winding of a rotary electric machine also including a rotor, in particular for a vehicle. The device includes at least one temperature sensor, capable of providing a measurement representative of the temperature of the rotor and/or stator of the rotary electric machine, and a temperature estimator module, capable of providing an estimate representative of the temperature of this rotor and/or this stator. A control device generates, in a main mode of operation, setpoints for the inverter/rectifier by using, as a signal representative of the temperature, the measurement provided by the temperature sensor, and the estimate provided by the temperature estimator module, for all or some of the rotation speeds of the rotor.

The present invention relates to a device for controlling an inverter/rectifier capable of being electrically connected to the electrical stator winding of a rotary electric machine, this rotary electric machine having in particular a permanent-magnet rotor. The invention is for example integrated in a vehicle, for example a motor vehicle or any other form of mobility involving hybrid or electric propulsion, and the rotary electric machine provides electric or hybrid propulsion for this vehicle.

The inverter/rectifier may, in this application, be inserted between the electrical stator winding of the machine and the on-board electrical system of the vehicle.

It is known practice, in order to control the inverter/rectifier in a main mode of operation, to take into account the temperature of active parts of the rotary electric machine, for example the stator and/or the rotor, by using the measurement provided by a temperature sensor. Taking into account the temperature in this way makes it possible, in a known manner, to thermally protect the machine by adapting its control for the temperature of all or some of its components in order to avoid excessive heating of the latter. This temperature sensor is, for example, a temperature probe such as an NTC or a PTC. The use of such sensors may prove insufficient, in particular to obtain sufficient precision over the entire operating range of the rotary electric machine. Moreover, such use of a sensor or sensors may prove restrictive, calibration of this sensor with respect to the electric machine being necessary.

The aforementioned disadvantage needs to be addressed.

The invention aims to meet this need and achieves this, according to one of its aspects, by way of a device for controlling an inverter/rectifier capable of being electrically connected to the electrical stator winding of a rotary electric machine also comprising a rotor, in particular for a vehicle, the device comprising:
at least one temperature sensor, capable of providing a measurement representative of the temperature of the rotor and/or stator of the rotary electric machine, and
a temperature estimator module, capable of providing an estimate representative of the temperature of this rotor and/or this stator,
the control device generating, in a main mode of operation, setpoints for the inverter/rectifier by using, as a signal representative of the temperature: the measurement provided by the temperature sensor, and the estimate provided by the temperature estimator module, for all or some of the rotation speeds of the rotor.

The invention makes it possible to add an additional robustness for taking into account the temperature of the rotary electric machine when producing the control for the inverter/rectifier, since both a temperature measurement and a temperature estimate are available for this production in the main mode of operation. This control may then be compatible with the criticality levels Asil B or Asil C in terms of operational safety of motor vehicles.

This availability of the measurement provided by the temperature sensor and of the estimate provided by the temperature estimator module to produce the control for the inverter/rectifier may exist in the main mode of operation over the entire operating range of the machine.

The temperature sensor may be one or more NTC or PTC temperature probes. As a variant or in addition, it may be one or more thermocouples. This sensor or these sensors may be arranged at the level of the coil heads of the stator, or opposite, axially speaking, the end of the rotor. When the rotor is a permanent-magnet rotor, such positioning may make it possible to obtain a temperature measurement close to these permanent magnets, the performance of which is sensitive to temperature.

The temperature estimator module may implement a thermal model of the rotary electric machine, for example a map linking temperature and phase currents in the electrical stator winding. This thermal model may implement correlations:
between the measurement of the phase currents in the electrical stator winding and the electromotive force of the machine as recalculated on the basis of the setpoints for these phase currents, or
between the measurement of these phase currents and the map of the machine.

The aforementioned correlations may be carried out both in static mode, i.e. at a constant speed, and in dynamic mode, for the aforementioned currents or voltages.

When it uses both the estimate provided by the temperature estimator module and the measurement provided by the temperature sensor as a signal representative of the temperature, the control device may fuse these data to generate the setpoints for the inverter/rectifier. In one example, the measurement provided by the temperature sensor may by default be the only one used as a signal representative of the temperature and, at the time of this use, the engine torque setpoint is compared with this engine torque as estimated by way of the values of the phase currents of the electrical stator winding. If the difference between the torque setpoint and the torque as estimated exceeds a given value, the estimate provided by the temperature estimator module is used as a signal representative of the temperature instead of the measurement provided by the temperature sensor.

The control device may comprise:
at least one position sensor, capable of providing a measurement representative of the position of the rotor, and
a position estimator module, capable of providing an estimate representative of the position of the rotor,
and, in the main mode of operation, the control device may then:
generate setpoints for the inverter/rectifier by using, as a signal representative of the position of the rotor, only the measurement provided by the position sensor, for a first range of rotation speeds of the rotor, and
generate setpoints for the inverter/rectifier by using, as a signal representative of the position of the rotor, at least the estimate provided by the position estimator module, in particular this estimate and the measurement provided by the position sensor, for a second range of rotation speeds of the rotor, the values of which are greater than those of the first range.

The control may then use as a signal representative of the position of the rotor:
only the measurement from the position sensor for the first speed range, and
only the estimate from the position estimator module for the second speed range, or the measurement from the position sensor and the estimate from the position estimator module for the second speed range.

In order to determine the position of the rotor of the rotary electric machine, the advantages of a signal obtained by measurement and a signal obtained by estimation may thus be combined, since: for the first speed range, benefits are gained from the accuracy of the position sensor, which has been calibrated by the equipment manufacturer, and for the second speed range, benefits are gained from the best torque accuracy of the position estimator module for these speeds and, where appropriate, still of the position sensor.

In the main mode of operation, the device may benefit both in the first speed range and in the second speed range from the measurement provided by the position sensor, and:
use it as a signal representative of the position of the rotor only in the first speed range to control the inverter/rectifier, only the estimate provided by the position estimator module then being used as a signal representative of the position of the rotor in the second speed range for this control, or
use it as a signal representative of the position of the rotor in the first speed range and in the second speed range to control the inverter/rectifier.

When this position measurement is not used to control the inverter/rectifier, it may, however, be compared with the estimate from the position estimator module to verify the correct operation of this estimator module.

In this same main mode of operation, the device may benefit both in the first speed range and in the second speed range from the estimate provided by the position estimator module, even if it uses this estimate as a signal representative of the position of the rotor only in the second speed range. When this estimate is not used to control the inverter/rectifier, it may, however, be compared with the measurement from the position sensor to verify the correct operation of this sensor and consequently to detect any failure of this sensor.

When it uses both the estimate provided by the position estimator module and the measurement provided by the position sensor as a signal representative of the position of the rotor, the device may fuse these data to generate the setpoints for the inverter/rectifier. In one example of this case, even in the second speed range, the measurement provided by the speed sensor may by default be the only one used as a signal representative of the position of the rotor and, at the time of this use, the engine torque setpoint is compared with this engine torque as estimated by way of the values of the phase currents of the electrical stator winding. If the difference between the torque setpoint and the torque as estimated exceeds a given value, the estimate provided by the position estimator module is used as a signal representative of the position of the rotor instead of the measurement provided by the position sensor.

Within the meaning of the present application:
a signal representative of the position of the rotor encompasses a speed or acceleration signal, the position then being obtained by one or more integration operations, and/or also encompasses a frequency signal for the phase voltages in the electrical stator winding of the rotary electric machine,
a position sensor also encompasses a speed or acceleration sensor, or a frequency sensor for the phase voltages in the electrical stator winding,
a position estimator module also encompasses a speed or acceleration or frequency estimator module for the phase voltages in the electrical stator winding,
the main mode of operation of the inverter/rectifier is a mode in which no failure in the rotary electric machine and in the on-board electrical system of the vehicle is detected by the control device,
“axially” means “parallel to the axis of rotation of the shaft”,
“radially” means “in a plane perpendicular to the axis of rotation of the shaft and along a line intersecting this axis of rotation”, and
“circumferentially” means “in a plane perpendicular to the axis of rotation of the shaft and moving around this axis”.

The control device as described above may have sufficient redundancy to be compatible with the criticality levels Asil B or Asil C in terms of operational safety of motor vehicles.

In all of the above, the position sensor may be chosen from: a Hall effect sensor, a resolver, an inductive sensor, or a sensor at the end of the rotor shaft.

In all of the above, the position sensor may have an electrical accuracy of less than or equal to 1°, as an absolute value. A sensor with such accuracy may be advantageous in that it may make it possible to obtain a torque accuracy of less than or equal to 1 N·m, as an absolute value. Such a sensor may, in one example, have a harmonic ratio of less than 2% per harmonic, for speeds up to 20 000 rpm.

The position estimator module may be self-calibratable. This estimator module uses, for example, masked time data to adjust itself.

In all of the above, the upper limit of the first speed range may coincide with the lower limit of the second speed range, this common limit being for example greater than 100 rpm, for example 200 rpm or 300 rpm, being in particular equal to 500 rpm.

The position sensor and the temperature sensor may be grouped together in the same packaging, being for example overmolded by the same shell.

The control device may have an auxiliary mode of operation in which it generates setpoints for the inverter/rectifier by using, as a signal representative of the position of the rotor, only the estimate provided by the position estimator module, for all or some of the rotation speeds of the rotor. Such an auxiliary mode may correspond to the detection of a failure of the position sensor, in which case the control device may decide to no longer use the measurement provided by this position sensor even though this measurement would still be available. Such a mode of operation may correspond to the return-to-garage mode already mentioned.

Independently or in addition, in this auxiliary mode of operation, the device may generate setpoints for the inverter/rectifier by using, as a signal representative of the temperature, only the estimate provided by the temperature estimator module, for all or some of the rotation speeds of the rotor. The detection of a failure of the temperature sensor may thus be taken into account.

In all of the above, the control device may be a digital processing circuit, implementing logic gates, counters and a memory: The electronic component is an application-specific integrated circuit (ASIC), for example.

The invention also relates, according to another of its aspects, to a device for controlling an inverter/rectifier capable of being electrically connected to the electrical stator winding of a rotary electric machine also comprising a rotor, in particular for a vehicle, the device comprising:
at least one position sensor, capable of providing a measurement representative of the position of the rotor, and
a position estimator module, capable of providing an estimate representative of the position of the rotor, the control device having a main mode of operation in which:
it generates setpoints for the inverter/rectifier by using, as a signal representative of the position of the rotor, only the measurement provided by the position sensor, for a first range of rotation speeds of the rotor, and
it generates setpoints for the inverter/rectifier by using, as a signal representative of the position of the rotor, at least the estimate provided by the position estimator module, in particular this estimate and the measurement provided by the position sensor, for a second range of rotation speeds of the rotor, the values of which are greater than those of the first range.

All that has been mentioned above applies to this other aspect of the invention, in particular the choice of values for the upper limit of the first range of rotation speeds, whether or not this upper limit is equal to the lower limit of the second range of rotation speeds, and in particular the sensitivity of the position sensor.

The invention also relates, according to another of its aspects, to a propulsion unit of an electric or hybrid vehicle, comprising:
a rotary electric machine, comprising a stator and a, in particular permanent-magnet, rotor,
an inverter/rectifier electrically connected to the electrical stator winding and capable of being connected to the on-board electrical system of the vehicle, and
the control device as defined above.

The rotary electric machine may have a rated supply voltage of 48 V. As a variant, this rotary electric machine may have a rated supply voltage of greater than 200 V.

The rotor may be a permanent-magnet rotor. The rotor does not have an electrical excitation winding for example. The rotor may be formed by a stack of laminations inside which the permanent magnets are positioned.

In all of the above, the electrical stator winding may be of polyphase type. Independently of its number of phases, the electrical stator winding may be formed by wires or by conductor bars connected to one another. Each slot of the stator frame may receive multiple conductors, for example 2, 4 or 6.

In all of the above, the rotary electric machine may comprise a cooling circuit for the stator in which fluid such as air or liquid circulates. This liquid may be water or oil.

The rotor may be cooled by this same cooling circuit or by another cooling circuit in which air, or liquid such as oil, circulates.

In all of the above, the rotor may comprise any number of pole pairs, for example three, four, six or eight pole pairs.

The rotary electric machine may have a rated electric power of 4 KW, 8 KW, 15 KW, 25 kW or more.

The on-board electrical system of the vehicle comprises, for example, two subsystems between which is inserted a switching system defining a DC/DC voltage converter.

One of the inverter/rectifier and DC/DC voltage converter may implement controllable electronic switches, such as gallium nitride (GaN), silicon carbide (SiC) or silicon transistors.

The first electrical subsystem, which is suitable for being connected to the inverter/rectifier, has for example a rated voltage of 48 V or a rated voltage greater than 200 V, and the second electrical subsystem has for example a rated voltage of 12 V.

The first subsystem may have a battery and an electrical energy storage unit formed by one or more capacitors and arranged in parallel with the DC output of the inverter/rectifier.

The capacitance of this electrical energy storage unit is in particular between 2000 μF and 4000 μF, for example of the order of 3000 μF.

The invention also relates, according to another of its aspects, to a hybrid or electric vehicle powertrain, comprising:
the unit defined above, and
a gearbox, comprising pinions, defining gearbox ratios, and
a front axle and a rear axle,
the shaft of the rotary electric machine being rigidly connected, for conjoint rotation:
   to an input shaft of the gearbox, or
   to the output shaft of the gearbox, or
   to idler pinions of the gearbox, or
   to the front axle or the rear axle.

As a variant, the shaft of the electric machine may be rigidly connected, for conjoint rotation, to the crankshaft of the internal combustion engine of the vehicle, when the powertrain comprises such an internal combustion engine. In such a case, the rotary electric machine may comprise a pulley or any other means of connection to the rest of the powertrain of the vehicle. The electric machine is for example connected, in particular via a belt, to the crankshaft of the internal combustion engine of the vehicle.

The powertrain may comprise a dry or wet dual clutch, each of the output shafts of the dual clutch then forming an input shaft for the gearbox.

The invention also relates, according to another of its aspects, to a method for controlling an inverter/rectifier electrically connected to the electrical stator winding of a rotary electric machine having a rotor, in particular a permanent-magnet rotor, in particular for a vehicle, in which method, according to a main mode of operation, setpoints for the inverter/rectifier are generated by using, as a signal representative of the temperature: the measurement representative of this temperature provided by a temperature sensor and the estimate representative of this temperature provided by a temperature estimator module, for all or some of the rotation speeds of the rotor.

All or some of the above also applies to this other aspect of the invention.

The invention will be better understood upon reading the following description of non-limiting examples thereof and with reference to the appended drawing, in which:

FIG. 1 schematically and partially shows a powertrain to which an exemplary embodiment of the invention may be applied:

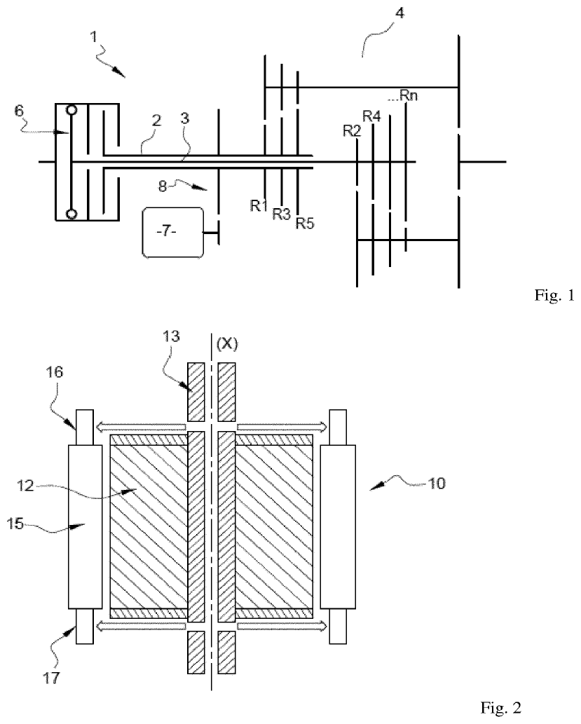

FIG. 2 schematically shows an example of a rotary electric machine of the system of FIG. 1, immersed in oil:

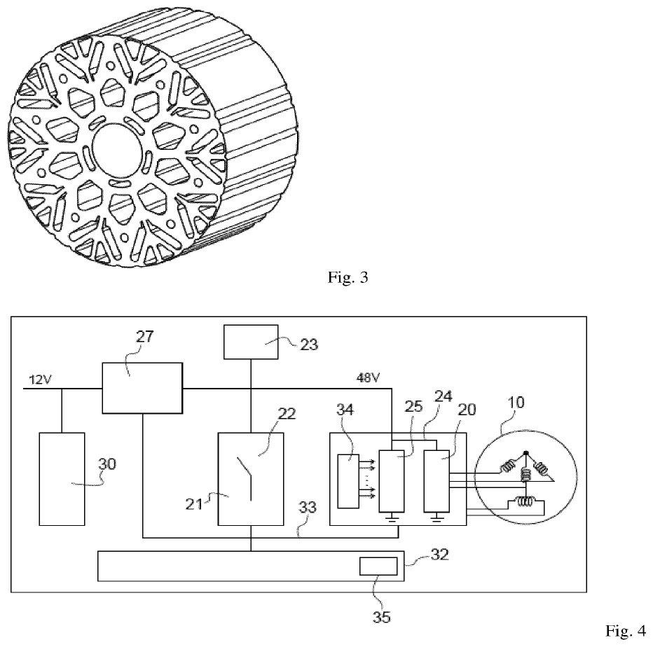

FIG. 3 shows, in isolation, an example of the rotor of the rotary electric machine of FIG. 2:

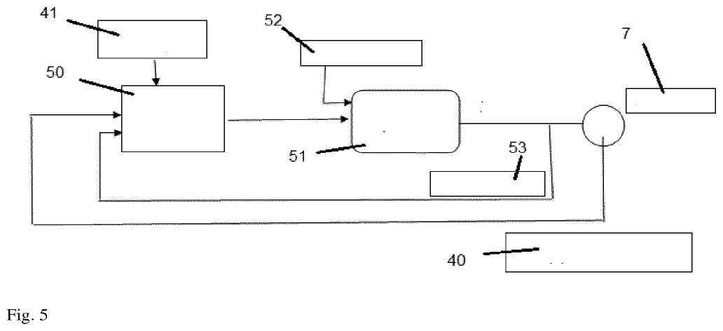

FIG. 4 schematically shows the electrical circuit of the rotary electric machine of the powertrain of FIGS. 1 and 2: and

FIG. 5 schematically shows an example of control of the inverter/rectifier of the circuit of FIG. 4 in accordance with the position of the rotor.

FIG. 1 shows a powertrain 1 to which the invention may be applied. In this case, the powertrain 1 comprises a dual clutch 6 that may be dry or wet, with disks or plates.

This dual clutch has two output shafts 2 and 3, which in this case are concentric. Each of these shafts defines an input shaft of a gearbox 4. The gearbox 4 comprises, inside a casing filled with oil, a plurality of pinions defining a plurality of gear ratios R1-Rn. The shaft 2 in this case is associated with odd gear ratios and the shaft 3 is associated with even gear ratios.

The output torque of the gearbox 4 is transferred to the wheels of the vehicle, in order to propel this vehicle.

The powertrain 1 is hybrid or electric, comprising a rotary electric machine 7. This rotary machine 7 is installed inside the casing of the gearbox 4. In the example under consideration, the shaft of the rotary machine 7 is capable of engaging by meshing with a pinion 8 rigidly connected to the input shaft 2 of the gearbox associated with the odd gear ratios, but other positions are possible for the rotary electric machine 7, for example it can mesh with a pinion rigidly connected to the input shaft 3 of the gearbox associated with the even gear ratios. In addition, positions for the rotary electric machine 7 outside the casing of the gearbox 4 are possible.

This rotary electric machine 7 may form an electric propulsion source for the vehicle. The rotary electric machine 7 comprises a casing, not shown in FIG. 2. Inside this casing, it also comprises a shaft 13, a rotor 12 rigidly connected to the shaft 13 for conjoint rotation, and a stator 10 surrounding the rotor 12. The rotational movement of the rotor 12 occurs about an axis X. The rotary electric machine 7 in this case is a synchronous machine.

Although not shown, the casing may comprise a front bearing and a rear bearing, which are assembled together, and may each have a hollow shape and centrally support a respective ball bearing for rotatably mounting the shaft 13.

In this exemplary embodiment, the stator 10 comprises a frame 15 in the form of a stack of laminations provided with slots, for example of the semi-closed or open type, provided with slot insulation for mounting the polyphase electrical winding of the stator. Each phase comprises a winding passing through the slots of the frame 15 and forming, with all the phases, a front winding head 16 and a rear winding head 17 on either side of the frame 15 of the stator. The windings are obtained, for example, using a continuous wire covered with enamel or conductive elements in the form of a bar, such as pins connected to each other. Each slot may receive multiple conductors, for example 2, 4 or 6 conductors.

In this case, the electrical winding of the stator defines a dual three-phase system, just one of these systems being shown in FIG. 4, each of these three-phase systems implementing a star or delta configuration the outputs of which are connected to an inverter/rectifier 20. As a variant, the electrical winding of the stator may define a single three-phase system.

The rotor 12 in FIG. 2 is formed by a stack of laminations, as shown in FIG. 3. There may be any number of pole pairs defined by the rotor 12, for example between three and eight, for example equal to three, four, six or eight. The rotor 12 receives a plurality of permanent magnets, not shown in these FIGS. 2 and 3, but received in housings formed in the stack of laminations.

FIG. 2 also shows that the shaft 13 is hollow, with oil circulating through it. Openings made in the shaft 13 and shown in FIG. 2 allow oil to be radially sprayed into the machine, so that the rotor and the stator are immersed in oil, in the example under consideration.

In the example under consideration, the machine comprises a sensor 40 for measuring the position of the rotor, not shown in FIG. 2. This sensor implements, for example, three Hall effect cells interacting with a magnetic target rigidly connected to the rotor for conjoint rotation, but other sensors are possible, such as a resolver, an inductive sensor or a sensor at the end of the rotor shaft. The sensor measures the position of the rotor, for example. As will be seen hereinafter, there is also provision for a module 41 estimating the position of the rotor.

The machine also comprises, in the example under consideration, one or more temperature sensors, not shown. These are thermocouples or NTCs, for example. These sensors may measure the temperature of the permanent magnets of the rotor, being then positioned, axially speaking, opposite the end of the rotor. There is also provision for a module estimating the temperature of the permanent magnets, in the example under consideration.

The electrical stator winding of the rotary electric machine 7 belongs to an electrical circuit comprising the inverter/rectifier 20. This inverter/rectifier 20 is inserted between the electrical winding of the stator and a first subsystem of the on-board electrical system of the vehicle, the rated voltage of which is equal to 48 V in the example described. The inverter/rectifier 20 comprises for example multiple switching arms, each arm implementing two transistors connected in series and separated by a mid-point. Each transistor is a gallium nitride (GaN), silicon carbide (SiC) or silicon transistor, for example.

The first subsystem of the on-board electrical system also comprises, in the example described, a battery 21 connected to the rest of this first subsystem by a disconnection switch 22. The first subsystem may optionally also comprise one or more consumers 23, including, for example, but not limited to, an electric supercharger.

In the example described, an electrical energy storage unit 25 is arranged at the terminals of the DC output 24 of the inverter/rectifier 20 for which the voltage is measured in the example under consideration, said electrical energy storage unit being formed, for example, by a capacitor or by an assembly comprising multiple capacitors. This electrical energy storage unit 25 has for example a capacitance of between 3000 μF and 4000 μF.

In the example under consideration, the electrical circuit also comprises a DC/DC voltage converter 27 inserted between the first subsystem and a second subsystem of the on-board electrical system. Similarly to the inverter/rectifier 20, the DC/DC voltage converter comprises, for example, transistors which may be of the same type as those mentioned above. The second subsystem of the on-board electrical system has a rated voltage of 12 V, for example.

In a known manner, this second subsystem may comprise a battery 30 and also consumers, not shown, which may be selected from the following non-limiting list: lighting system, electric power assisted steering system, braking system, air conditioning system, or car radio system.

In the example under consideration, the electrical circuit also comprises a control unit 32, which may be the central computer of the vehicle or be dedicated to all or part of the powertrain 1. This control unit 32 communicates via a data network 33, which is of the CAN type, for example, with various components of the electrical circuit, as may be seen in FIG. 4.

The control unit 32 may receive a control device 35, which will now be described. The control device 35 is an ASIC, for example. However, the invention is not limited to the case where the control device 35 is integrated in the control unit 32. In the example described, the control device 35 generates setpoints for the inverter/rectifier 20 in accordance with the rotation speed of the rotor of the rotary electric machine 7 and in accordance with the temperature of the active parts of this machine 7, including, for example, the temperature of the permanent magnets of this rotor.

For this purpose, and according to a main mode of operation, an example of which will be described with reference to FIG. 5, the control device 35:
generates setpoints for the inverter/rectifier 20 by using, as a signal representative of the position of the rotor, only the measurement provided by the position sensor 40, for a first range of rotation speeds of the rotor, and
generates setpoints for the inverter/rectifier 20 by using, as a signal representative of the position of the rotor, the estimate provided by the position estimator module 41 and the measurement provided by the position sensor 40, for a second range of rotation speeds of the rotor, the values of which are greater than those of the first range.

The first speed range corresponds, for example, to speeds below 500 rpm and the second speed range then corresponds to speeds above 500 rpm.

According to this example, the input of a block 50 receives:
the estimate provided by the position estimator module 41,
the measurement provided by the position sensor 40, and
the measurement of the phase currents in the electrical stator winding.

This block 50 carries out, in the second range of values, a fusion between these two position inputs, on the basis of which it produces an estimate of the engine torque on the shaft of the rotor of the machine. This torque estimate is received at the input of a block 51 which compares this torque estimate with a torque request received via a block 52.

The block 51 produces, in order to control the inverter/rectifier 20, setpoints for the phase currents and the phase voltages in the electrical stator winding. The block 53 takes a measurement of these phase currents, this measurement being received at the input of the block 50, as has already been seen.

In the first speed range, although the input of the block 50 receives the estimate provided by the position estimator module 41, this information is not taken into account by this block 50 in the main mode of operation to control the inverter/rectifier 20. Only the measurement provided by the position sensor 40 is used in this first speed range by the control device 35 to generate the setpoints for the phase currents and the phase voltages in the electrical stator winding.

Although not shown in FIG. 5, in the example described, the control of the inverter/rectifier 20 by the control device 35 takes into account in the main mode of operation the temperature of the permanent magnets of the rotor. For the entire operating range in this main mode, the control device 35 may generate setpoints for the inverter/rectifier 20 by using, as a signal representative of the temperature, the measurement provided by the aforementioned temperature sensor and the estimate provided by the aforementioned temperature estimator module.

The input of the block 50 of FIG. 5 again receives, for example:
the estimate provided by the temperature estimator module, and
the measurement provided by the temperature sensor.

The block 50 carries out, for all the speed values in this main mode of operation, a fusion between these two temperature inputs when it produces the aforementioned estimate of the engine torque on the shaft of the rotor, an estimate received at the input of the block 51 of FIG. 5.

In an auxiliary mode of operation, the failure of the position sensor 40 and/or the temperature sensor may be detected. In this case, the control device 35 may, independently of the value of the rotation speed of the rotor, use only the estimate provided by the estimator module 41 as a signal representative of the position of the rotor and/or use only the estimate provided by the estimator module as a signal representative of the temperature of the permanent magnets to generate the setpoints for the inverter/rectifier 20. Such an auxiliary mode of operation may correspond to a return-to-garage mode.

The invention is not limited to what has just been described.

1. A propulsion unit for an electric or hybrid vehicle, comprising:
a rotary electric machine comprising a stator and a, permanent-magnet, rotor,
an inverter/rectifier electrically connected to the electrical stator winding and capable of being connected to the on-board electrical system of the vehicle, and
a control device of the inverter/rectifier, the device comprising:
at least one temperature sensor, capable of providing a measurement representative of the temperature of the permanent magnets of the rotor, and
a temperature estimator module, capable of providing an estimate representative of the temperature of these permanent magnets of the rotor,
the control device generating, in a main mode of operation, setpoints for the inverter/rectifier by using, as a signal representative of the temperature: the measurement provided by the temperature sensor, and the estimate provided by the temperature estimator module, for all or some of the rotation speeds of the rotor.

2. The unit as claimed in claim 1, wherein the temperature sensor is an NTC or PTC temperature probe or a thermocouple.

3. The unit as claimed in claim 1, wherein the temperature estimator module implements a thermal model of the rotary electric machine, in particular a map linking temperature and phase currents in the electrical stator winding.

4. The unit as claimed in claim 1, the control device comprising:
at least one position sensor, capable of providing a measurement representative of the position of the rotor, and
a position estimator module, capable of providing an estimate representative of the position of the rotor,
the control device generating, in the main mode of operation:
setpoints for the inverter/rectifier by using, as a signal representative of the position of the rotor, only the measurement provided by the position sensor, for a first range of rotation speeds of the rotor, and
setpoints for the inverter/rectifier by using, as a signal representative of the position of the rotor, at least the estimate provided by the position estimator module, in particular the estimate provided by the position estimator module and the measurement provided by the position sensor, for a second range of rotation speeds of the rotor, the values of which are greater than those of the first range.

5. The unit as claimed in claim 4, wherein the position sensor is selected from: a Hall effect sensor, an inductive sensor, a resolver, or a sensor at the end of the rotor shaft.

6. The unit as claimed in claim 4 or 5, wherein the upper limit of the first range of speeds coincides with the lower limit of the second range of speeds, this common limit being greater than 200 rpm, being in particular equal to 500 rpm.

7. The unit as claimed in claim 4, having an auxiliary mode of operation in which it generates setpoints for the inverter/rectifier by using, as a signal representative of the temperature, only the estimate provided by the temperature estimator module, for all or some of the rotation speeds of the rotor.

8. The unit as claimed in claim 7, wherein, in the auxiliary mode of operation, the device generates setpoints for the inverter/rectifier by using, as a signal representative of the position of the rotor, only the estimate provided by the position estimator module, for all or some of the rotation speeds of the rotor.

9. The unit as claimed in claim 1, the rotary electric machine having a rated voltage of 48 V.

10. A hybrid or electric vehicle powertrain, comprising:
the unit as claimed in claim 1,
a gearbox, comprising pinions, defining gearbox ratios, and
a front axle and a rear axle,
the shaft of the rotary electric machine being rigidly connected, for conjoint rotation:
to an input shaft of the gearbox, or
to the output shaft of the gearbox, or
to idler pinions of the gearbox, or
to the front axle or the rear axle.

11. The powertrain as claimed in claim 10, comprising a, dry or wet, dual clutch, each of the output shafts of the dual clutch then forming an input shaft for the gearbox.

12. A method for controlling an inverter/rectifier electrically connected to the electrical stator winding of a rotary electric machine having a permanent-magnet rotor, in particular for a vehicle,
in which method, according to a main mode of operation, setpoints for the inverter/rectifier are generated by using, as a signal representative of the temperature of the permanent magnets of the rotor: the measurement representative of this temperature provided by a temperature sensor and the estimate representative of this temperature provided by a temperature estimator module, for all or some of the rotation speeds of the rotor.

13. The unit as claimed in claim 2, wherein the temperature estimator module implements a thermal model of the rotary electric machine, in particular a map linking temperature and phase currents in the electrical stator winding.

14. The unit as claimed in claim 2, the control device comprising:
at least one position sensor, capable of providing a measurement representative of the position of the rotor, and
a position estimator module, capable of providing an estimate representative of the position of the rotor,
the control device generating, in the main mode of operation:
setpoints for the inverter/rectifier by using, as a signal representative of the position of the rotor, only the measurement provided by the position sensor, for a first range of rotation speeds of the rotor, and
setpoints for the inverter/rectifier by using, as a signal representative of the position of the rotor, at least the estimate provided by the position estimator module, in particular the estimate provided by the position estimator module and the measurement provided by the position sensor, for a second range of rotation speeds of the rotor, the values of which are greater than those of the first range.

15. The unit as claimed in claim 5, wherein the upper limit of the first range of speeds coincides with the lower limit of the second range of speeds, this common limit being greater than 200 rpm, being in particular equal to 500 rpm.

16. The unit as claimed in claim 5, having an auxiliary mode of operation in which it generates setpoints for the inverter/rectifier by using, as a signal representative of the temperature, only the estimate provided by the temperature estimator module, for all or some of the rotation speeds of the rotor.

17. The unit as claimed in claim 16, wherein, in the auxiliary mode of operation, the device generates setpoints for the inverter/rectifier by using, as a signal representative of the position of the rotor, only the estimate provided by the position estimator module, for all or some of the rotation speeds of the rotor.

18. The unit as claimed in claim 2, the rotary electric machine having a rated voltage of 48 V.

19. A hybrid or electric vehicle powertrain, comprising:
the unit as claimed in claim 2,
a gearbox, comprising pinions, defining gearbox ratios, and
a front axle and a rear axle,
the shaft of the rotary electric machine being rigidly connected, for conjoint rotation:
to an input shaft of the gearbox, or
to the output shaft of the gearbox, or
to idler pinions of the gearbox, or
to the front axle or the rear axle.

20. The unit as claimed in claim 3, the control device comprising:
at least one position sensor, capable of providing a measurement representative of the position of the rotor, and
a position estimator module, capable of providing an estimate representative of the position of the rotor,
the control device generating, in the main mode of operation:
setpoints for the inverter/rectifier by using, as a signal representative of the position of the rotor, only the measurement provided by the position sensor, for a first range of rotation speeds of the rotor, and
setpoints for the inverter/rectifier by using, as a signal representative of the position of the rotor, at least the estimate provided by the position estimator module, in particular the estimate provided by the position estimator module and the measurement provided by the position sensor, for a second range of rotation speeds of the rotor, the values of which are greater than those of the first range.
